(19) United States
(12) Patent Application Publication
(10) Pub. No.: US 2009/0006708 A1
(43) Pub. Date: Jan. 1, 2009

(54) PROPORTIONAL CONTROL OF PCI EXPRESS PLATFORMS

(76) Inventor: Henry Lee Teck Lim, Pulau Pinang (MY)

Correspondence Address: BUCKLEY, MASCHOFF & TALWALKAR LLC, 50 LOCUST AVENUE, NEW CANAAN, CT, 06840, US

(21) Appl. No.: 11/771,069

(22) Filed: Jun. 29, 2007

(51) Int. Cl. G06F 13/36

(52) U.S. Cl. 710/314

(57) ABSTRACT

A system may comprise M data lanes where M is an integer greater than 1, a plurality of PCIe devices, and a PCIe lane controller. Each device may be coupled to corresponding ones of a plurality of PCIe endpoints. The PCIe lane controller may automatically distribute N data lanes to a first of the plurality of PCIe endpoints, and may distribute M minus N data lanes to a remaining plurality of endpoints, where N is an integer.

### BACKGROUND

Computer systems often transfer large volumes of data, illustrating a need for high-bandwidth data buses. However, transferring data over a high-bandwidth data bus requires more power than transferring data over a lower-bandwidth data bus. The use of high-bandwidth data buses may therefore increase power consumption of a computer system.

A typical computer system may also contain a central processing unit (“CPU”) and/or one or more chipsets such as a graphics processing unit (“GPU”) or a memory control unit (“MCU”) that may each consume large quantities of power. The combination of high power consumption elements and high-bandwidth data busses create a need to reduce power consumption.

### BRIEF DESCRIPTION OF THE DRAWINGS

FIG. 1 is a block diagram of a system according to some embodiments.

FIG. 2 is a block diagram of a method according to some embodiments.

FIG. 3 is a block diagram of a method according to some embodiments.

### DETAILED DESCRIPTION

The several embodiments described herein are solely for the purpose of illustration. Embodiments may include any currently or hereafter-known versions of the elements described herein. Therefore, persons in the art will recognize from this description that other embodiments may be practiced with various modifications and alterations.

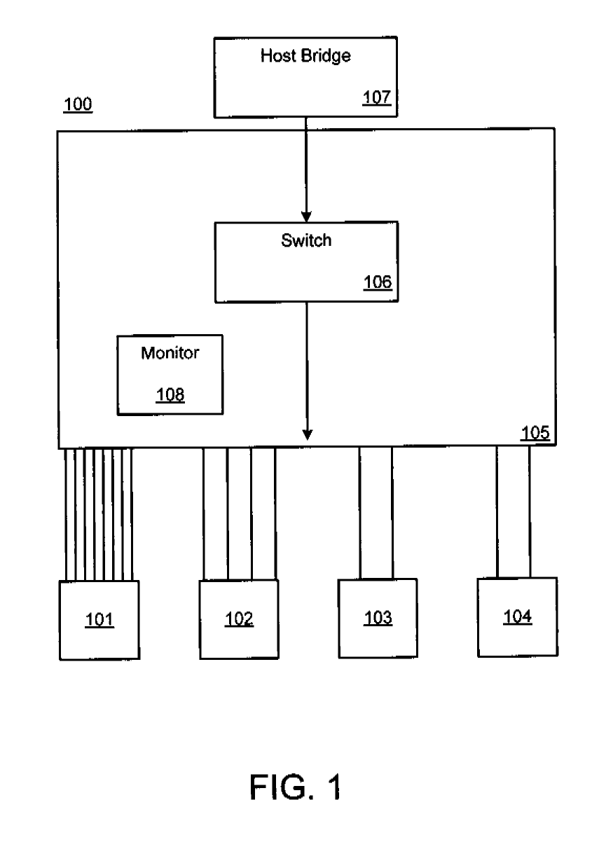

Referring now to FIG. 1, an embodiment of a system 100 is shown. In some embodiments, FIG. 1 may illustrate a Peripheral Component Interconnect Express (“PCIe”) interface comprising a PCIe bus. A PCIe bus is a bus for attaching peripheral devices to a computer motherboard or computer system and may allow high bandwidth transfers between attached components. In some embodiments system 100 may be a proportional control system.

A PCIe bus may be scalable, high-speed, serial, point-to-point, and hot pluggable/hot swappable. The system 100 may be implemented in a computer server, a desktop or a handheld device but embodiments are not limited thereto System 100 may comprise a plurality of endpoints and, as illustrated, system 100 may comprise a first endpoint 101, a second endpoint 102, a third endpoint 103, a fourth endpoint 104, a switch 106, a host bridge 107, a monitor 108, and an automatic lane controller 105. Each endpoint 101/102/103/104 nay be coupled to the lane controller 105 via one or more data lanes.

The host bridge 107 may be, but is not limited to a northbridge chipset, a GPU or a MPU. The host bridge 107 may comprise a set of serial data lanes to communicate with a computing system (not shown). In the illustrated example, the host bridge 107 may comprise 16 data lanes and each endpoint 101/102/103/104 may be located on a data bus. In some embodiments, each endpoint 101/102/103/104 may be connected to a respective external device that may be routed via the switch 106 to the host bridge 107.

The switch 106 may reassign the data lanes of the host bridge 107 to each endpoint 101/102/103/104 according to a proportion determined by a monitor device 108. In this regard, the monitor device 108 determines a status associated with each endpoint 101/102/103/104 and a bandwidth requirement associated with each endpoint 101/102/103/104. In some embodiments, the monitor device 108 may comprise a Link Training Status and State Machine (“LTSSM”). In some embodiments, the monitor device 108 maybe external to the automatic lane controller 105.

The switch 106 may receive a signal from the automatic lane controller 105 to distribute and/or redistribute data lanes. In some embodiments, the switch 106 may comprise a switch fabric that connects each endpoint 101/102/103/104 such as a fan-out from the host bridge 107. The automatic lane controller 105 may be a logic control unit or part of a northbridge chipset where the northbridge chipset handles communications between a CPU, memory, a PCIe interface and/or a southbridge chipset.

Each data lane between the host bridge 107 and each endpoint 101/102/103/104 may be a serial data link. In some embodiments, each data lane may comprise two sets of differential pairs a transmit pair and a receive pair. Throughput, measured as data rate, may be scaled by using different width links to send/receive data. For example, throughput may be increased by using 2 lanes, 4 lanes, 8 lanes, 16 lanes, or 32 lanes instead of using a single data lane. In some embodiments, each data lane may comprise an embedded data clock. A PCIe bus may utilize 8 bit/10 bit encoding, as known in the art, which may allow a larger number of bytes per data word to be sent over each data lane. For example, in response to a request for more bandwidth, a data word may be encoded for transmission on one or more data lanes using 8 bit/10 bit encoding.

In some embodiments, only a portion of the data lanes may be active at a given time. Since each active data lane consumes power, a total power consumption of a PCIe bus may scale proportionally with a number of data lanes used to connect each endpoint 101/102/103/104 to a respective external device. If, for example, the host bridge 107 comprises 16 data lanes, and the power consumption is 100 milliwatts per active data lane per direction, then the power consumption may be 200 milliwatts per active data lane. Therefore the host bridge 107 may consume a total of 3.2 Watts of power. However, if only 50 percent of the active data lanes to an endpoint 101/102/103/104 exhibiting a high bandwidth requirement, then system 100 may result in a reduction of 1.6 watts of power or 50 percent of the bus power, if only one endpoint device is coupled to the PCIe bus.

Monitor device 108 may detect status information associated with each endpoint 101/102/103/104, such as, but not limited to, bandwidth requirements, a busy wait state, or a determination if an external device is connected. Monitor device 108 may transmit the status information to the host bridge 107. The monitor device 108 may communicate with the automatic lane controller 105 and provide data to elicit the automatic lane controller 105 to adjust a proportion of data lanes connected to external devices. Each endpoint 101/102/103/104 may transmit and/or receive data and exhibit a bandwidth requirement such as high, medium, and low bandwidth requirements. In some embodiments, the automatic lane controller 105 may be integrated into the host bridge 107 or may function as an external element to implement bandwidth optimization and reduce power consumption.

For example, a first device may be coupled to the first endpoint 101 may require more bandwidth than any other device coupled to system 100. As illustrated, endpoint 101 has been allocated 50 percent (e.g. 8 data lanes) of the 16 available serial data lanes on the data bus based on a bandwidth requirement associated with the first endpoint 101. If the bandwidth requirement for the first endpoint 101 is reduced or if the endpoint 101 becomes inactive, the lane controller 105 may reduce a number of data lanes assigned to the first endpoint 101 (i.e. free up unused data lanes). The automatic lane controller 105 may place the freed data lanes in a reserved state if the data lanes are not needed by another endpoint 102/103/104 or may automatically allocate the data lanes to another endpoint 102/103/104 that exhibits a second-highest bandwidth requirement.

The aforementioned example illustrates that the first endpoint 101 may utilize up to 50 percent of all available data lanes. Since power consumption may be calculated based on a number of data lanes in use, system 100 may reduce power consumption by 50 percent.

Continuing with the previous example, bandwidth requirements may be automatically assigned to each endpoint 101/102/103/104 via system 100. As illustrated, the second endpoint 102 may exhibit a second-highest bandwidth requirement and thus may be allocated 50 percent (e.g. 4 data lanes) of the available data lanes that were not assigned to the first endpoint 101. The third endpoint 103 and the fourth endpoint 104 may each be allocated any remaining unassigned data lanes proportionally. Thus, as illustrated, third endpoint 103 and fourth endpoint 104 are each assigned 50 percent of the remaining available data lanes that were not assigned to the first endpoint 101 or the second endpoint 102.

In some embodiments, if only one endpoint device is coupled to the PCIe bus, the automatic lane controller 105 may shutdown all unused or idle data lanes in order to reduce power consumption via a hardware control associated with a motherboard BIOS or via a software control. The automatic lane controller 105 may initiate the shutdown.

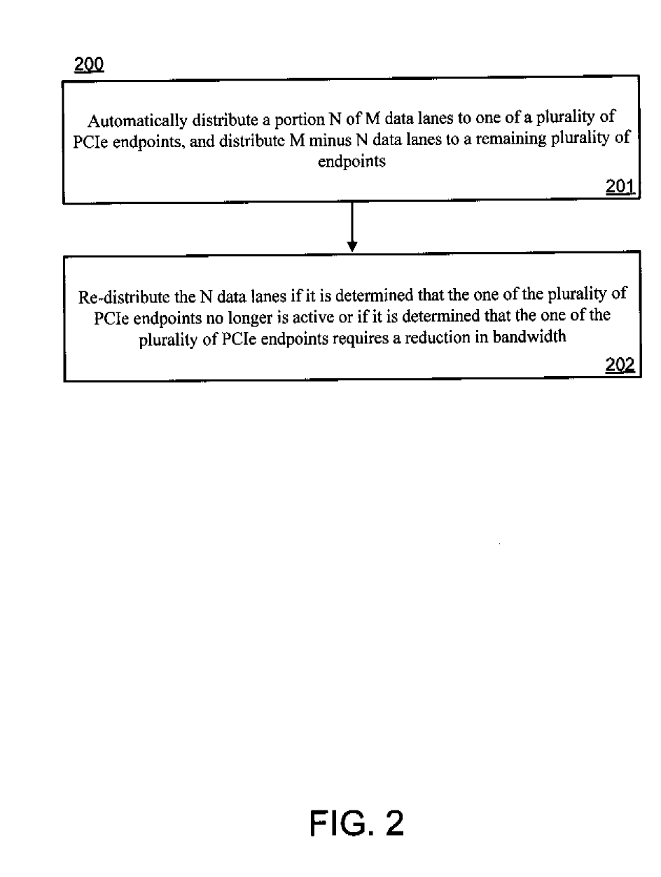

Now referring to FIG. 2, an embodiment of a method 200 is illustrated. The method 200 may be executed by any combination of hardware, software, and firmware, including but not limited to, the system 100 of FIG. 1. At 201, a portion N of M data lanes are automatically distributed to one of a plurality of PCIe endpoints, and M minus N data lanes are distributed to a remaining plurality of endpoints. For example, a system may comprise 16 data lanes and 4 endpoints as illustrated in FIG. 1. A first portion N of the data lanes (i.e. 8 in this example) may be distributed to a first endpoint 101. The remaining 8 data lanes (i.e. 16 total lanes (M) minus 8 distributed lanes (N)) may be automatically distributed to the second endpoint 102, the third endpoint 103, and the fourth endpoint 104. In some embodiments, N and M may be integers.

In some embodiments, a plurality of PCIe devices that are coupled to a corresponding ones of a plurality of PCIe endpoints may be detected at 201. The detecting may be performed by a monitor device that polls each of the plurality of PCIe endpoints and determines a bandwidth required by one of the plurality of PCIe devices coupled to one of a plurality of PCIe endpoints. A data link may be established to the one of a plurality of PCIe devices via one or more data lanes.

In some embodiments of 201, a lane controller 105 may distribute M/2 of the data lanes to a first of the plurality of PCIe endpoints, and may distribute M/4 of the remaining data lanes to a second of the plurality of PCIe endpoints, where the first of the plurality of PCIe endpoints requires more bandwidth than the remaining plurality of PCIe endpoints, and the second of the plurality of PCIe endpoints requires less bandwidth than the first of the plurality of PCIe endpoints but requires more bandwidth than the remaining ones of the plurality of PCIe endpoints.

Continuing with the above example, if the first endpoint 101 requires the most bandwidth, the second endpoint 102 requires a second most bandwidth, and the third endpoint 103 and the fourth endpoint 104 require the same amount of bandwidth, the lane controller 105 may distribute 4 data lanes (e.g. 8 remaining divided by 2) to the second end point and the third endpoint 103 and the fourth endpoint 104 may each be assigned 2 data lanes (e.g. 8 remaining divided by 4).

Next, at 202, the N data lanes are re-distributed if it is determined that the one of the plurality of PCIe endpoints no longer is active or if it is determined that the one of the plurality of PCIe endpoints requires a reduction in bandwidth. For example, if the first endpoint 101 no longer is active (e.g. not sending or receiving data) or if the first endpoint 101 no longer requires a bandwidth provide by 8 data lanes, then all or a portion of the data lanes assigned to the first endpoint 101 may be re-distributed to other end points (e.g. the second endpoint 102, the third endpoint 103, and/or the fourth endpoint 104).

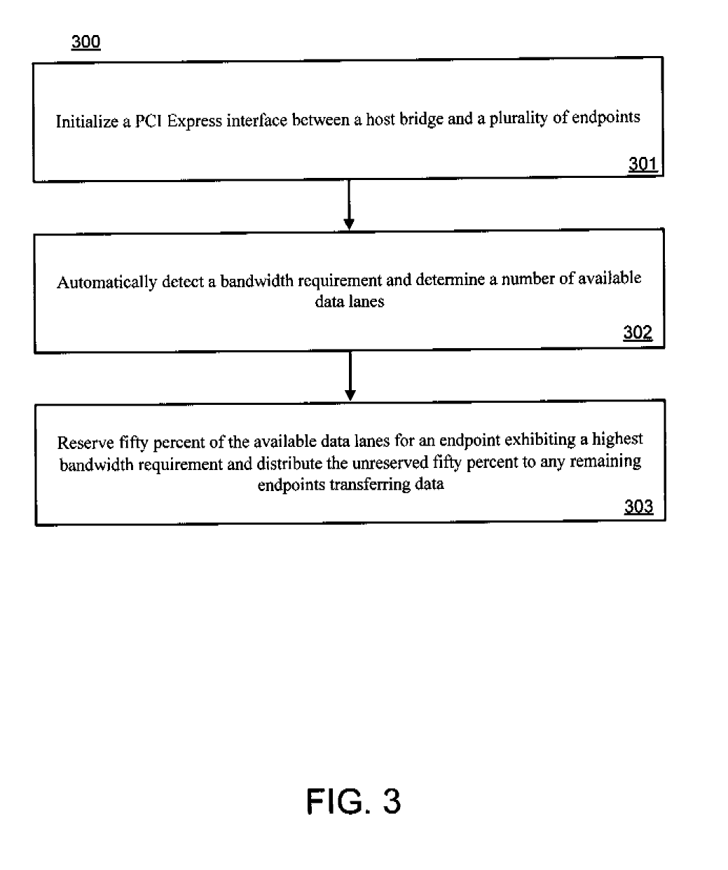

FIG. 3 illustrates an embodiment of a method 300. Method 300 may comprise a data link width negotiation by a LTSSM. At 301, a PCIe interface between a host bridge and a plurality of endpoints may be initialized. In some embodiments Of 301, the LTSSM may monitor and establish a link between two components over the PCIe interface. The link may be established at a physical level and may include an associated width (i.e. a multi-lane link).

Next, at 302, a bandwidth requirement is automatically detected and a number of available data lanes is determined. According to some embodiments of 302, when establishing a link, the LTSSM may start in a detect state to discover if a first device is connected to one of a plurality of endpoints and then the LTSS may enter a polling state to monitor if a second device is connected to any of the remaining the plurality of endpoints.

At 303, 50 percent of the available data lanes are reserved for an endpoint exhibiting a highest bandwidth requirement and the unreserved fifty percent are distributed to any remaining endpoints transferring data. Once a data connection has been established, each component may enter a configuration state and the configuration of the link may be negotiated between the two components. After the negotiation has been completed, the automatic lane controller 105 may reserve one or more serial data lanes by a method of proportional control such as method 200 of FIG. 2.

Various modifications and changes may be made to the foregoing embodiments without departing from the broader spirit and scope set forth in the appended claims.

What is claimed is:

1. A system comprising:
M data lanes, where M is an integer greater than 1;
a plurality of PCIe devices, each device coupled to a corresponding one of a plurality of PCIe endpoints; and
a PCIe lane controller to automatically distribute N data lanes to a first of the plurality of PCIe endpoints, and to distribute M minus N data lanes to a remaining plurality of endpoints.

2. The system of claim 1, wherein the lane controller is to distribute M/2 of the data lanes to a first of the plurality of PCIe endpoints, and is to distribute M/4 to a second of the plurality of PCIe endpoints, where the first of the plurality of PCIe endpoints requires more bandwidth than the remaining plurality of PCIe endpoints, and the second of the plurality of PCIe endpoints requires less bandwidth than the first of the plurality of PCIe endpoints but requires more bandwidth than the remaining ones of the plurality of PCIe endpoints.

3. The system of claim 1, wherein the lane controller is to re-distribute the M/2 data lanes distributed to the first of the plurality of PCIe endpoints when the first of the plurality of PCIe endpoints no longer is active or the first of the plurality of PCIe endpoints requires less bandwidth.

4. The system of claim 1, further comprising
a monitor to poll each endpoint, wherein the monitor is to determine that a PCIe device is connected to a PCIe endpoint, is to determine a bandwidth required by the PCIe device and is to establish a data link to the PCIe device.

5. The system of claim 1, wherein each data lane comprises a differential signal pair.

6. A method comprising:
automatically distributing a portion N of M data lanes to one of a plurality of PCIe endpoints, and distributing M minus N data lanes to a remaining plurality of endpoints, where N and M are integers; and
re-distributing the N data lanes if it is determined that the one of the plurality of PCIe endpoints no longer is active or if it is determined that the one of the plurality of PCIe endpoints requires a reduction in bandwidth.

7. The method of claim 6, further comprising:
detecting that a plurality of PCIe devices are coupled to a corresponding ones of a plurality of PCIe endpoints, wherein the detecting is based on a monitor that polls each of the plurality of PCIe endpoints;
determining a bandwidth required by one of the plurality of PCIe devices coupled to one of a plurality of PCIe endpoints; and
establishing a data link to the one of a plurality of PCIe devices.

8. The method of claim 6, wherein the lane controller is to distribute M/2 of the data lanes to a first of the plurality of PCIe endpoints, and is to distribute M/4 of the remaining data lanes to a second of the plurality of PCIe endpoints, where the first of the plurality of PCIe endpoints requires more bandwidth than the remaining plurality of PCIe endpoints, and the second of the plurality of PCIe endpoints requires less bandwidth than the first of the plurality of PCIe endpoints but requires more bandwidth than the remaining ones of the plurality of PCIe endpoints.
